(19) United States
(12) Patent Application Publication
(10) Pub. No.: US 2026/0241898 A1
(43) Pub. Date: Aug. 20, 2026

(54) Lifting Device for Vehicle Maintenance

(71) Applicant: Qingdao Runbell Industrial Co., Ltd, Shandong (CN)

(72) Inventor: Xiaoxun YANG, Shandong (CN)

(73) Assignee: Qingdao Runbell Industrial Co., Ltd, Shandong (CN)

(21) Appl. No.: 19/057,151

(22) Filed: Feb. 19, 2025

(51) Int. Cl. B60T 3/00

(52) U.S. Cl. CPC B60T 3/00

(57) ABSTRACT

The present disclosure provides a lifting device for vehicle maintenance, which comprises a supporting base and a supporting platform, wherein a positioning groove is disposed on the supporting base; the supporting platform and the supporting base are fixed by inserting through the positioning groove; the upper surface of the supporting platform is a circular arc, and four conical barrels are disposed on the supporting platform; the supporting platform is provided with side grooves at the positions of the conical barrels, the top of the supporting platform is provided with an arc-shaped surface, and friction grooves are disposed on the arc-shaped surface.

### TECHNICAL FIELD

The present disclosure relates to the technical field of vehicle maintenance tools, particularly to a lifting device for vehicle maintenance.

### BACKGROUND

In the field of traditional vehicle maintenance, vehicle maintenance is a general term for vehicle maintenance and repair, that is, to find out the cause of the failure by technical means, and take certain measures to eliminate the failure and restore it to a certain performance and safety standard. At present, lifting devices are generally needed to jack up the vehicle and the chassis in the market, so that maintenance personnel can repair the bottom of the vehicle. When such devices are used, if the ground is uneven, it is likely to cause unstable support; at the same time, supporting the tires is very important during maintenance. Therefore, in order to solve the above problems, a supporting and fixing device for vehicle maintenance is urgently needed to solve the above problems.

In view of the above technical problems, the CN patent CN207394340U discloses a cushion block, which is used for lifting vehicles, and comprises an upper cushion block, wherein the upper end of an upper cushion block is provided with a supporting part that can be matched with wheels of the vehicle; a lower cushion block is disposed below the upper cushion block; reinforcing plates are provided between the upper cushion block and the lower cushion block and are respectively connected to the upper cushion block and the lower cushion block. The cushion block has a certain supporting effect on vehicle tires, but because of its simple structure, there is no reinforcing supporting structure or structure to enhance friction with vehicle tires, therefore it lacks practicality, and there is still a technical defect that it cannot stably support vehicle tires during automobile maintenance.

### SUMMARY

The present disclosure provides a lifting device for vehicle maintenance to solve the problems raised by the above background technology.

In order to achieve the object of the present disclosure, the present disclosure adopts the following technical solution.

The present disclosure provides a lifting device for vehicle maintenance, which includes a supporting base and a supporting platform, wherein the supporting base is provided with a positioning groove, and the supporting platform and the supporting base are fixed by inserting through the positioning groove; and an upper surface of the supporting platform is a circular arc, the supporting platform is provided with four conical barrels, and the supporting platform is provided with side grooves at the positions of the conical barrels.

The present disclosure further provides a combined cushion block for maintenance of automobile tires, which comprises a supporting base, wherein a supporting platform is inserted on the supporting base, a top of the supporting platform is provided with an arc-shaped surface, and friction grooves are formed on the arc-shaped surface.

### BRIEF DESCRIPTION OF DRAWINGS

The drawings, which constitute a part of this application, serve to help further understanding of the present disclosure. The illustrative embodiments of the present disclosure and the description thereof are used to explain the present disclosure, and do not constitute undue limitations on the present disclosure. In the drawings:

FIG. 1 is a schematic perspective view of a preferred embodiment of the present disclosure;

FIG. 2 is a bottom view of the supporting platform in FIG. 1;

FIG. 3 is a schematic perspective view of the supporting base in FIG. 1;

FIG. 4 is a schematic sectional view of an X-shaped groove recessed on the upper surface of the supporting platform in FIG. 1;

FIG. 5 is a bottom view of the supporting base in FIG. 3;

FIG. 6 is a schematic perspective view of another embodiment of the present disclosure;

FIG. 7 is a schematic perspective view of another embodiment of the present disclosure, showing the specific positions of the middle connecting groove and the edge connecting groove;

FIG. 8 is a schematic sectional view of the conical groove in FIG. 6;

FIG. 9 is a schematic sectional view of the connecting groove in FIGS. 6 and 7;

FIG. 10 is a schematic view of the embodiment shown in FIG. 1 when it is placed under an automobile tire;

FIG. 11 shows left and right side views of the embodiment shown in FIG. 1, which do not appear in the specific embodiment;

FIG. 12 is a front side view of the supporting platform in FIG. 1, showing the circular arc shape of the upper surface of the supporting platform;

FIG. 13 is another embodiment of the circular arc shape of the upper surface of the supporting platform of the embodiment shown in FIG. 1.

The above drawings include the following reference signs:

Lifting device for vehicle maintenance (100); Supporting base (110); Supporting platform (120); Positioning groove (111); Conical barrel (121); Side groove (125); Trapezoidal groove (122); X-shaped groove (123); Drainage hole (124); Water collecting tank (112); Crossing groove (113); Drainage channel (114); Side groove plate (126); Access hole (127); Reinforcing rib (115); Upper reinforcing plate (128); Lower reinforcing plate (117); Fixing hole (116); Combined cushion block (200) for automobile maintenance tires; Arc-shaped surface (129); Conical groove (1291); Connecting groove (1292); Middle connecting groove (1293); Edge connection groove (1294); Protrusion (300); Communication groove (301); Lateral edge (302); Corner (303); Front and rear side surfaces (a); Left and right side surfaces (b).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

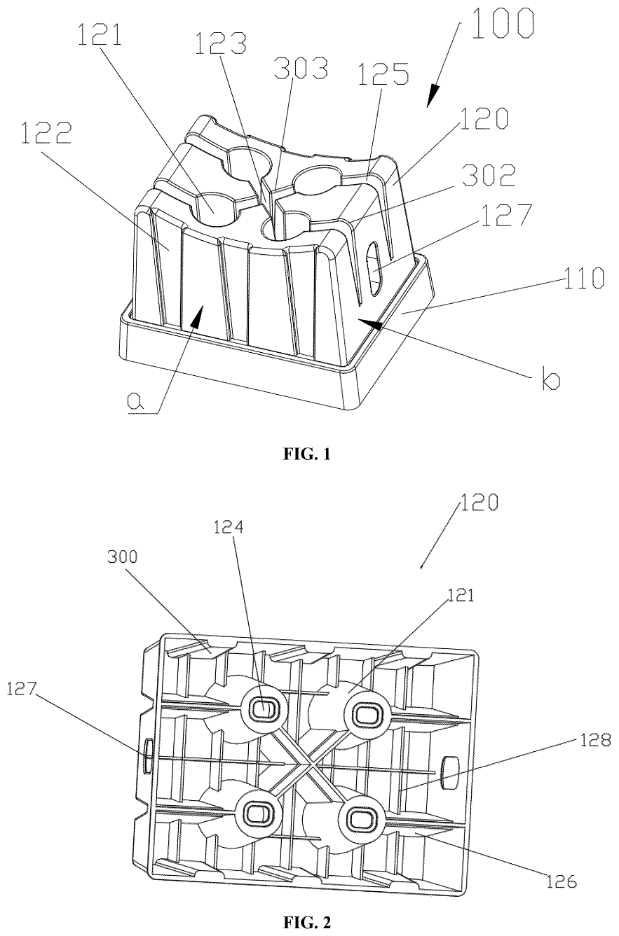

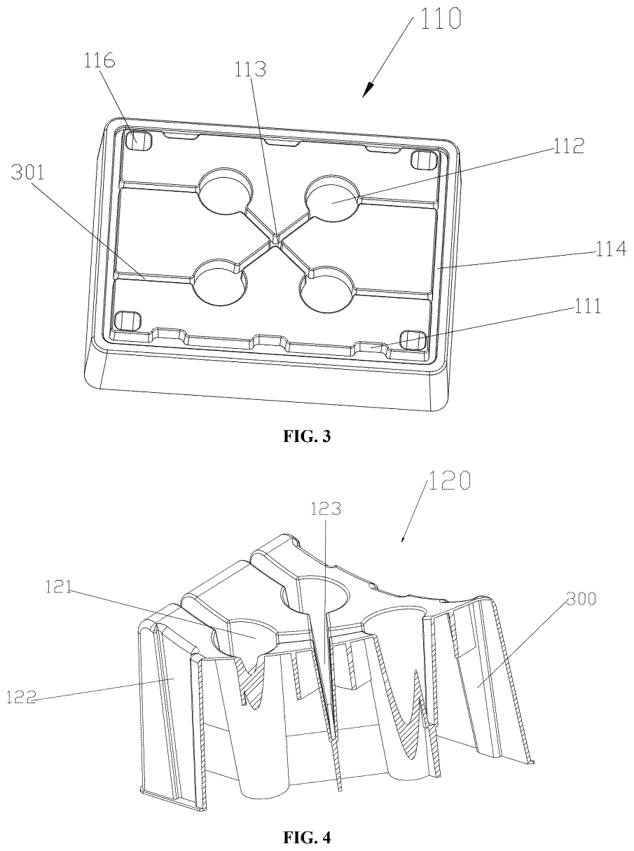

Referring to FIG. 1, the present disclosure provides a lifting device for vehicle maintenance 100, which includes a supporting base 110 and a supporting platform 120. The supporting platform 120 has four sides, namely, the front, back, left and right sides, and each side including an outer surface and an inner surface, and the four sides together constitute the main outline of the supporting platform 120. Trapezoidal grooves 122 are recessed inward on the front and rear side surfaces a of the supporting platform 120, and the trapezoidal grooves 122 are recessed inward to form a protrusion 300 on the inner surface of the supporting platform 120 (see FIG. 2). The supporting base 110 is also provided with a positioning groove 111 (see FIG. 3). The shape of the positioning groove 111 is configured to fit the protrusion 300 and can accommodate at least a part of the protrusion 300, so that the supporting platform 120 can be inserted into the protrusion 300 through the positioning groove 111, so as to realize the detachable connection with the supporting base 110.

In this embodiment, the detachable connection between the supporting platform 120 and the supporting base 110 greatly improves the flexibility and versatility of the lifting device for vehicle maintenance 100 for vehicle maintenance. In other embodiments, the connection between the supporting platform 120 and the supporting base 110 can also be connected by snap connection, bolt connection and other connection methods.

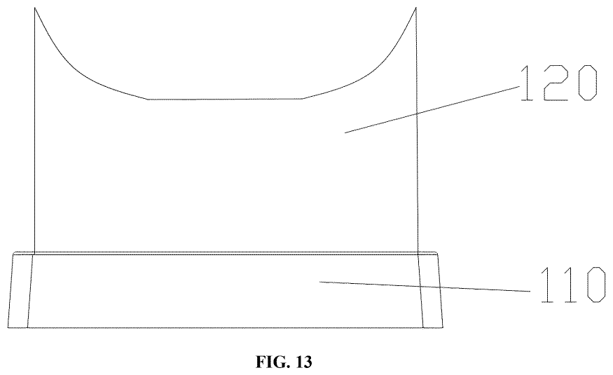

In this embodiment, when viewed from the front and rear sides a, the upper surface of the supporting platform 120 is a circular arc (see FIG. 12), which is bent downward from the middle. The circular arc design enables the supporting platform 120 to better place and firmly fix the automobile tires (see FIG. 10), providing a good supporting platform for automobile maintenance. In other embodiments, the circular arc design is not limited thereto, and it can also be set as a step with low middle and high sides or any other shape that can achieve the effect of low middle and high sides (see FIG. 13). The supporting platform 120 has a certain height, which enables it to lift the automobile to a required position when in use, providing convenience for the maintenance, inspection or other operations of the automobile, ensuring that the operator can operate the automobile at a suitable height, and improving the work efficiency and safety.

As shown in FIG. 2, four conical barrels 121 are recessed downward from the upper surface of the supporting platform 120, and the radius of the conical barrels 121 gradually decreases from the upper surface to the lower surface. The conical barrels 121 can effectively collect various liquids generated in the process of automobile maintenance and discharge them smoothly, thus avoiding the accumulation of liquids on the supporting platform 120 and ensuring the smooth maintenance work.

In this embodiment, the front and rear sides a of the supporting platform 120 are both recessed inward from the outer surface to form the trapezoidal grooves 122, which penetrate the upper surface of the supporting platform 120 and terminate at the lower surface. The trapezoidal groove 122 is generally ladder-shaped. As shown in FIG. 1, the width of the trapezoidal groove 122 gradually decreases from the upper surface to the lower surface. The design of the trapezoidal groove 122, which is wide at the top and narrow at the bottom, makes the mounting and dismounting of the supporting platform 120 and the supporting base 110 more convenient. When the supporting platform 120 and the supporting base 110 are inserted and matched, the protrusions 300 (see FIG. 2) are closely attached to the positioning grooves 111 (see FIG. 3), which makes the installation of the supporting platform 120 and the supporting base 110 convenient and efficient, and the connection is stable and reliable. In other embodiments, the shape of the protrusion 300 can also be circular, polygonal and other shapes.

The supporting platform 120 is also provided with a side groove 125, which penetrates the upper surface of the supporting platform 120 and the left side surface (or right side surface) of the supporting platform 120 to be communicated with the conical barrel 121.

As shown in FIG. 1, in this embodiment, an X-shaped groove 123 is recessed downward from the upper surface of the supporting platform 120, and each end of the X-shaped groove 123 is configured to communicate with the conical barrel 121. The X-shaped groove 123 makes the upper surface of the supporting platform 120 form a plurality of corners 303, which can increase the friction between the supporting platform 120 and the automobile tires, improve safety, prevent the tires from slipping, and enhance the stability of the vehicle support, thus ensuring the smooth progress of the automobile maintenance work. As shown in FIG. 4, the cross section of the X-shaped groove 123 is triangular, and the width of the X-shaped groove 123 gradually decreases from the upper surface to the lower surface. When liquid appears during use, the X-shaped groove 123 communicates with each conical barrel 121, and the generated liquid can be guided to flow into each conical barrel 121. In other embodiments, the X-shaped groove can also be Z-shaped, D-shaped and other shapes that can communicate with each conical barrel 121 in order to adapt to different tire patterns.

As shown in FIG. 2 and FIG. 3, a water collecting tank 112 is recessed downward from the upper surface of the supporting base 110 at the position corresponding to the conical barrel 121. The water collecting tank 112 can efficiently collect various liquids generated during vehicle maintenance, avoid liquid accumulation in the working area, maintain the cleanliness and safety of the maintenance working environment, and ensure the smooth progress of the maintenance process. By punching holes in the bottom of the conical barrel 121, a drainage hole 124 is formed, and the drainage hole 124 can discharge the liquid accumulated in the conical barrel 121. Meanwhile, at the position corresponding to the X-shaped groove 123 on the supporting base 110, a crossing groove 113 is recessed downward from the upper surface of the supporting base 110, and each end of the crossing groove 113 is communicated with the water collection tank 112. A drainage channel 114 and a communication groove 301 are also recessed on the upper surface of the supporting base 110, and both ends of the communication groove 301 are respectively communicated with the drainage channel 114 and the water collection tank 112. The communication among the water collecting tank 112, the crossing groove 113 and the drainage channel 114 forms a complete drainage network, and this communication structure can guide the liquid to flow in a preset direction, so that the liquid can be gathered together in an orderly manner to prepare for the subsequent drainage work.

As shown in FIG. 1 and FIG. 2, both sides of the side groove 125 are provided with side groove plates 126, which are respectively connected to the conical barrel 121 and the supporting platform 120. This unique connection mode that the side groove 125 is recessed on the supporting platform 120 to connect the conical barrel 121 and the supporting platform 120 makes the side groove 125 form the lateral edges 302 on the supporting platform 120. These lateral edges 302 can strengthen the supporting effect, effectively improve the stability and bearing capacity of the whole structure, not only can fix the position of the conical barrel 121 on the supporting platform 120, but also effectively disperse the pressure exerted by the vehicle on the conical barrel 121 during vehicle maintenance, avoiding structural damage caused by excessive local stress, thus improving the reliability and durability of the whole lifting device for vehicle maintenance 100.

In this embodiment, the access hole 127 is formed by perforating the left and right side surfaces b of the supporting platform 120. Maintenance personnel can easily apply force through these access holes 127 to realize flexible movement and accurate positioning of the supporting platform 120, whether in the process of transporting the supporting platform 120 or in the process of installing or disassembling the device.

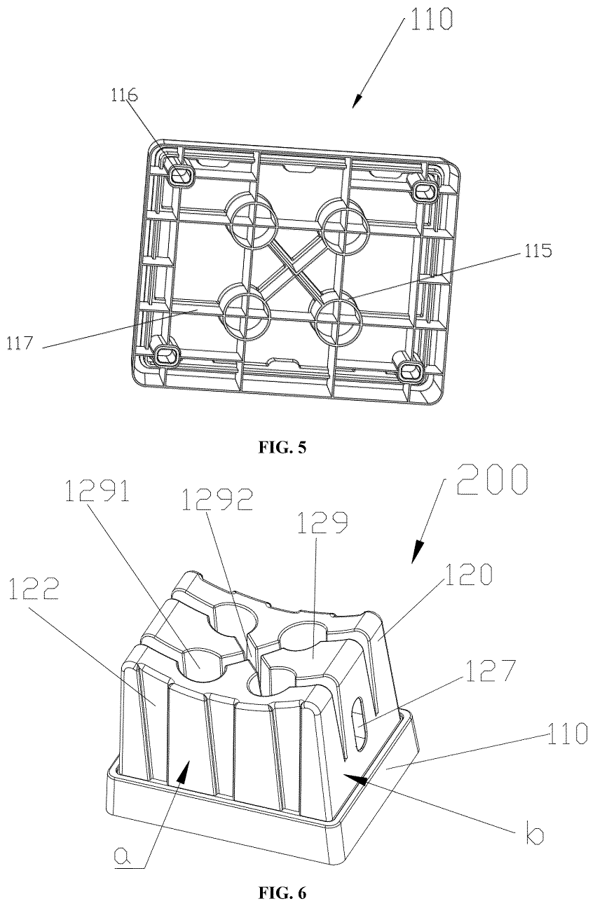

As shown in FIG. 2 and FIG. 5, in this embodiment, reinforcing ribs 115 extend downward from the bottom of the supporting base 110 at a position of the lower surface of the supporting base 110 corresponding to the conical barrel 121. The reinforcing ribs 115 can increase the stress strength of the supporting base 110, effectively disperse the pressure, avoid stress concentration, and ensure the stability and reliability of the whole structure. On the one hand, this layout can effectively enhance the bearing capacity of the supporting base 110 in key stress areas, and prevent structural deformation or damage caused by excessive stress on the conical barrel 121; on the other hand, this layout will not cause any interference to the normal use and operation of the supporting platform 120, ensuring the convenience and safety of maintenance personnel in the operation process. In other embodiments, the structural strength of the supporting base 110 can be increased by strengthening the wall thickness and increasing the supporting structure in addition to providing the reinforcing ribs 115.

Referring to FIG. 5, in this embodiment, the supporting base 110 is further provided with fixing holes 116, which penetrate the upper and lower surfaces of the supporting base 110. The fixing holes 116 can fix the supporting base 110 on the ground or other support surfaces by bolts or screws. The design of the fixing holes 116 not only ensures the stability of the supporting base 110 in different application scenarios, but also facilitates flexible adjustment according to actual needs. At the same time, the arrangement of the plurality of fixing holes 116 also provides a variety of installation modes and angles, further enhancing the applicability and flexibility of the supporting base 110. The supporting base 110 can also raise the height of the supporting platform 120 to meet the needs of different scenes.

As shown in FIG. 2 and FIG. 5, in this embodiment, the supporting platform 120 and the supporting base 110 are respectively provided with a plurality of reinforcing plate structures. A plurality of crisscross upper reinforcing plates 128 extend downward from the upper end of the inner surface of the supporting platform 120, and a plurality of crisscross lower reinforcing plates 117 extend downward from the inner surface of the supporting base 110. The arrangement of the reinforcing plate structure strengthens the bearing capacity of the supporting platform 120 and the supporting base 110, and ensures that the whole device is still stable and reliable when bearing the weight of the vehicle and various external forces.

Referring to FIG. 1, in this embodiment, all corners 303 on the outer surface of the supporting platform 120 and the outer surface of the supporting base 110 are rounded. This design not only makes the appearance of the supporting platform 120 more smooth and smooth, and avoids the potential safety hazards caused by sharp edges and corners, but also reduces the damage to the surface of the supporting platform 120 caused by collision or friction during use. At the same time, the rounding treatment also makes it more smooth for the supporting platform 120 to be fitted or matched with other components, which improves the overall assembly efficiency and aesthetics.

As shown in FIG. 6, the present disclosure further provides a combined cushion block 200 for maintenance of automobile tires, which includes a supporting base 110 and a supporting platform 120. The supporting base 110 is provided with a positioning groove 111 (see FIG. 3), and the supporting platform 120 is fixed with the supporting base 110 by insertion. The supporting base 110 and the supporting platform 120 are installed through the positioning groove 111 (see FIG. 3) and the protrusion 300 by insertion, and an arc-shaped surface 129 is recessed on the top of the supporting platform 120. Viewed from the front and rear side surfaces a, the arc-shaped surface 129 is bent downward from the middle (see FIG. 12), and the arc-shaped surface 129 is used for placing automobile tires (see FIG. 10). The supporting base 110 can raise the height of the supporting platform 120 to meet the needs of different scenes.

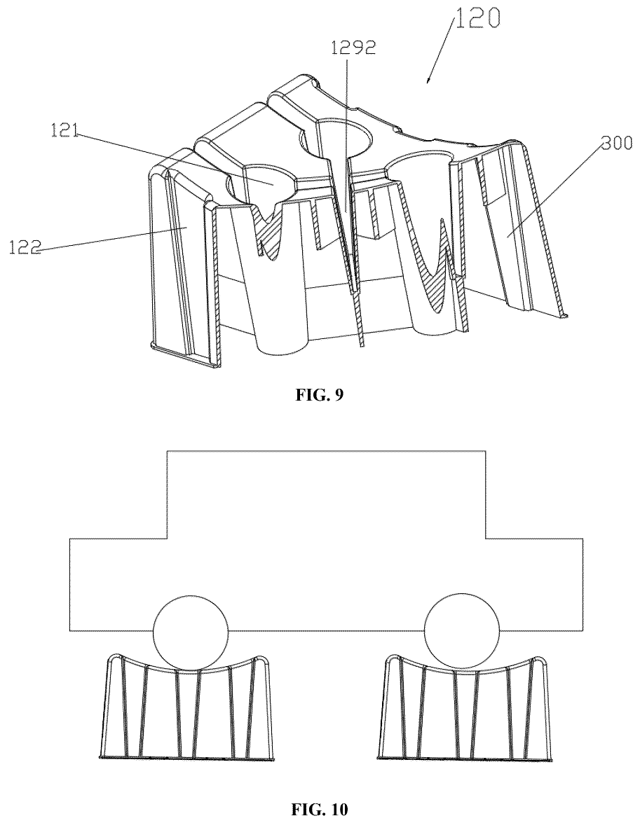

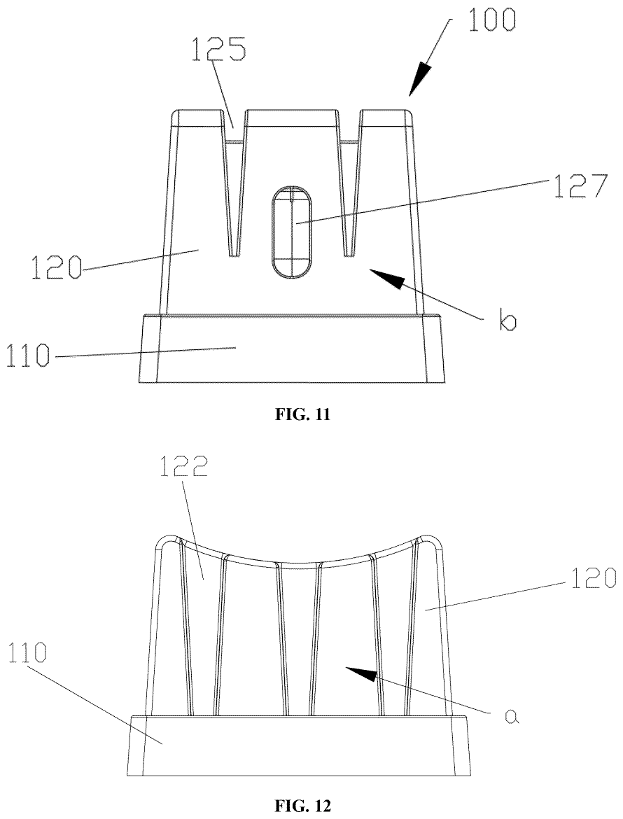

As shown in FIG. 6, friction grooves are recessed downward on the upper surface of the arc-shaped surface 129. The friction grooves include a conical groove 1291 (see FIG. 8) with a circular cross section and a connecting groove 1292 (see FIG. 9) with a triangular cross section. The circular cross section design of the conical groove 1291 enables the supporting platform 120 to effectively disperse pressure and reduce local wear when stressed, thus making the whole structure more solid and enhancing the damage resistance. By arranging friction grooves to effectively disperse the pressure between various parts of the supporting platform 120, the stability of the whole structure is greatly improved, which not only ensures the safety of the supporting platform 120 in a single use, but also ensures that it can always provide reliable support for vehicles in a long-term use process.

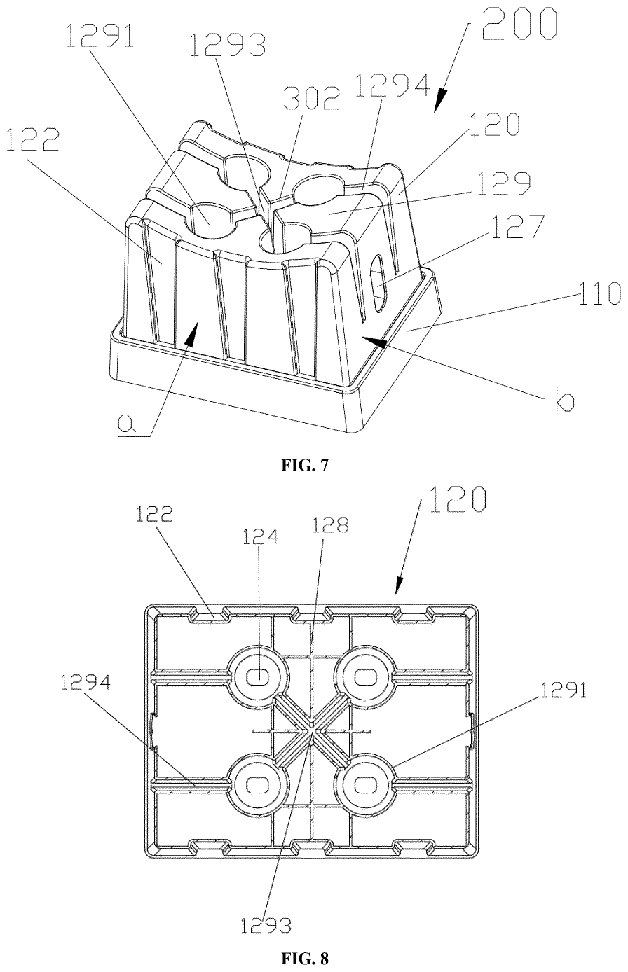

Referring to FIG. 7, in this embodiment, the connecting groove 1292 is further subdivided into a middle connecting groove 1293 and edge connecting grooves 1294. Each end of the middle connecting groove 1293 is connected to the conical groove 1291, and the edge connecting grooves 1294 penetrate the arc-shaped surface 129 and the left side surface (or the right side surface) of the supporting platform 120. With the middle connecting groove 1293 and the edge connecting grooves 1294, lateral edges are formed on the arc-shaped surface 129. The design of the lateral edges 302 increases the structural strength of the supporting platform 120 and improves its stability and bearing capacity. In addition, in other embodiments, the connecting groove 1292 can also take the shape of a ring, a diamond and the like to meet diverse design requirements and application scenarios.

In the description of the present disclosure, it should be appreciated that the orientation or positional relationship indicated by orientation words such as “front, back, upper, lower, left, right”, “lateral, vertical, horizontal” and “top, bottom” are usually based on the orientation or positional relationship shown in the attached drawings, just for the convenience of describing the present disclosure and simplifying the description. Unless otherwise stated, these orientation words do not indicate or imply that the device or element referred to must have a specific orientation or be constructed and operated in a specific orientation, therefore they cannot be construed as limiting the scope of protection of the present disclosure. The orientation words “inside and outside” refer to the inside and outside relative to the outline of each component itself.

For the convenience of description, spatially relative terms such as “above”, “on”, “on the upper surface of” and “upper” can be used here to describe the spatial positional relationship between a device or feature as shown in the drawings and other devices or features. It should be appreciated that spatially relative terms are intended to encompass different orientations in use or operation in addition to the orientation of the device depicted in the drawings. For example, if the devices in the drawings are inverted, devices described as “above” or “on” other devices or structures will be positioned as “below” or “under” other devices or structures. Thus, the exemplary term “above” can include both orientation of “above” and “below”. The device can also be positioned in other different ways (rotated by 90 degrees or in other orientations), and the spatial relative description used here is explained accordingly.

In addition, it should be noted that the words “first” and “second” are used to define parts for the convenience of distinguishing the corresponding parts. Unless otherwise stated, the above words have no special meaning, and thus they cannot be construed as limiting the protection scope of the present disclosure.

What has been described above is only the preferred embodiment of the present disclosure, and it is not intended to limit the present disclosure. For those skilled in the art, the present disclosure may have various modifications and changes. Any modification, equivalent substitution, improvement and the like made within the spirit and principle of the present disclosure shall fall into the protection scope of the present disclosure.

What is claimed is:

1. A lifting device for vehicle maintenance, comprising a supporting base and a supporting platform, wherein the supporting base is provided with a positioning groove, and the supporting platform and the supporting base are fixed by inserting through the positioning groove; and an upper surface of the supporting platform is a circular arc, the supporting platform is provided with four conical barrels, and the supporting platform is provided with side grooves at the positions of the conical barrels.

2. The lifting device for vehicle maintenance according to claim 1, wherein both sides of the supporting platform are provided with trapezoidal grooves, and the trapezoidal grooves penetrate from the upper surface of the supporting platform to a bottom edge of a lower surface of the supporting platform.

3. The lifting device for vehicle maintenance according to claim 1, wherein the supporting platform is provided with an X-shaped groove that is communicated with the conical barrels, and a cross section of the X-shaped groove is triangular.

4. The lifting device for vehicle maintenance according to claim 1, wherein a bottom of the conical barrel is provided with a drainage hole.

5. The lifting device for vehicle maintenance according to claim 4, wherein the supporting base is provided with water collection tanks at positions corresponding to the conical barrels, and the water collection tanks are communicated through crossing grooves.

6. The lifting device for vehicle maintenance according to claim 5, wherein the supporting base is provided with a plurality of drainage channels which are all communicated with the water collection tanks.

7. The lifting device for vehicle maintenance according to claim 1, wherein the conical barrel is connected to a side surface of the supporting platform through a side groove, and side groove plates at both sides of the side groove are connected to the conical barrel and the supporting platform.

8. The lifting device for vehicle maintenance according to claim 1, wherein both sides of the supporting platform are provided with access holes.

9. The lifting device for vehicle maintenance according to claim 1, wherein the supporting base is provided with reinforcing ribs at positions corresponding to the conical barrels, and the reinforcing ribs are disposed at one side of the supporting base far from the supporting platform.

10. The lifting device for vehicle maintenance according to claim 1, wherein the supporting base is provided with a plurality of fixing holes for fixing the position of the supporting base.

11. The lifting device for vehicle maintenance according to claim 1, wherein a plurality of crisscross upper reinforcing plates are disposed on the supporting platform, and a plurality of crisscross lower reinforcing plates are disposed below an upper surface of the supporting base.

12. The lifting device for vehicle maintenance according to claim 1, corners of an outer surface of the supporting platform are all rounded, and corners of an outer surface of the supporting base are all rounded.

13. A lifting device for vehicle maintenance, comprising a supporting base, wherein a supporting platform is inserted on the supporting base, and a top of the supporting platform is provided with an arc-shaped surface, wherein friction grooves are formed on the arc-shaped surface.

14. The lifting device for vehicle maintenance according to claim 13, wherein the friction grooves comprise a conical groove with a circular cross section and a connecting groove with a triangular cross section.

15. The lifting device for vehicle maintenance according to claim 14, wherein the connecting groove comprises a middle connecting groove and an edge connecting groove.

16. The lifting device for vehicle maintenance according to claim 13, wherein both sides of the supporting platform are provided with trapezoidal grooves, and the trapezoidal grooves penetrate from an upper surface of the supporting platform to a bottom edge of a lower surface of the supporting platform.

17. The lifting device for vehicle maintenance according to claim 14, wherein a bottom of the conical groove is provided with drainage holes, the supporting base is provided with water collection tanks at positions corresponding to the conical grooves, and the water collection tanks are communicated through crossing grooves; and the supporting base is provided with a plurality of drainage channels, and all the drainage channels are communicated with the water collection tanks.

18. The lifting device for vehicle maintenance according to claim 13, wherein both sides of the supporting platform are provided with access holes.

19. The lifting device for vehicle maintenance according to claim 13, wherein the supporting base is provided with a plurality of fixing holes for fixing the position of the supporting base.

20. The lifting device for vehicle maintenance according to claim 13, wherein a plurality of crisscross upper reinforcing plates are disposed on the supporting platform, and a plurality of crisscross lower reinforcing plates are disposed below an upper surface of the supporting base.
